(19) United States
(12) Patent Application Publication
(10) Pub. No.: US 2005/0108740 A1
(43) Pub. Date: May 19, 2005

(54) Movement for disk player

(76) Inventor: Hong-Chi Teng, Taichung (TW)

Correspondence Address: HONG-CHI TENG, 235 CHUNG-HO BOX 8-24, TAIPEI HSIEN, 235, TW

(21) Appl. No.: 10/715,193

(22) Filed: Nov. 18, 2003

(51) Int. Cl. G11B 7/08; G11B 7/085; G11B 7/09

(52) U.S. Cl. 720/659; 720/676

(57) ABSTRACT

A movement for disk player is constructed to a disk read head, a read head moving mechanism, a disk driving motor, a ferrite substrate for disk driving motor, and a driving motor control circuit disposed outside the ferrite substrate.

### BACKGROUND OF THE INVENTION

1. Field of the Invention

The present invention relates to a movement for disk player and, more particularly to a movement for CD-ROM play6er, DVD-ROM player, CD-RW player, VCD player, DVD player, or NP3 player.

2. Description of the Related Art

A conventional movement for disk player has a control PC board and a motor installed in a big-sized ferrite substrate. Because a disk player requires high precision, the processing and installation of the big-sized ferrite substrate are complicated, resulting in bulky volume, low productivity, and high manufacturing cost.

Therefore, it is desirable to provide a movement for disk player that eliminates the aforesaid drawbacks.

### SUMMARY OF THE INVENTION

The present invention has been accomplished under the circumstances in view. It is the main object of the present invention to provide a movement for disk player, which has the control PC board and the ferrite substrate separately designed so that the installation procedure can be simplified, the product size can be minimized, and the manufacturing cost can be greatly reduced.

To achieve this and other objects of the present invention, the movement for disk player comprises a read head, a read head moving mechanism, a disk driving motor, a ferrite substrate for the disk driving motor, and a separated driving motor control circuit board.

### BRIEF DESCRIPTION OF THE DRAWINGS

FIG. 1 is an exploded view of a movement for disk player according to the present invention.

FIG. 2 is a schematic assembly view of the movement for disk player according to the present invention.

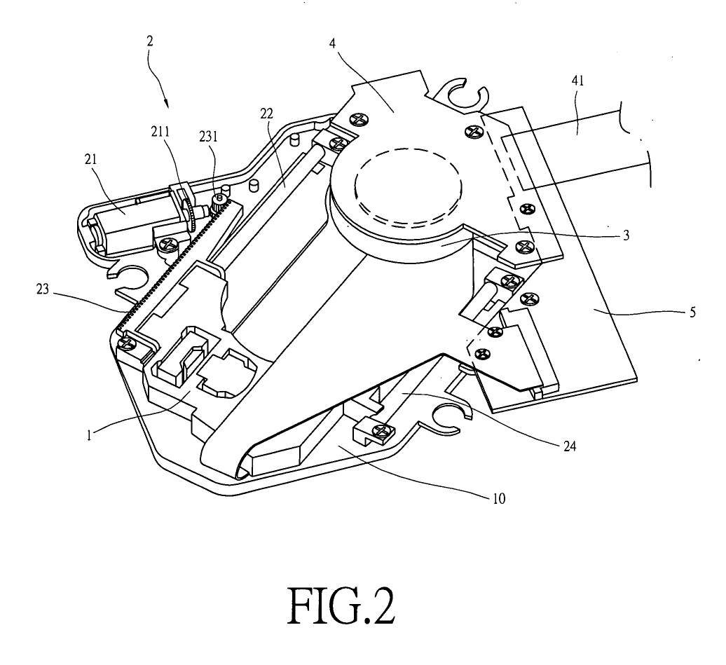

FIG. 3 is a top plain view of the movement for disk player according to the present invention.

### DETAILED DESCRIPTION OF THE PREFERRED EMBODIMENT

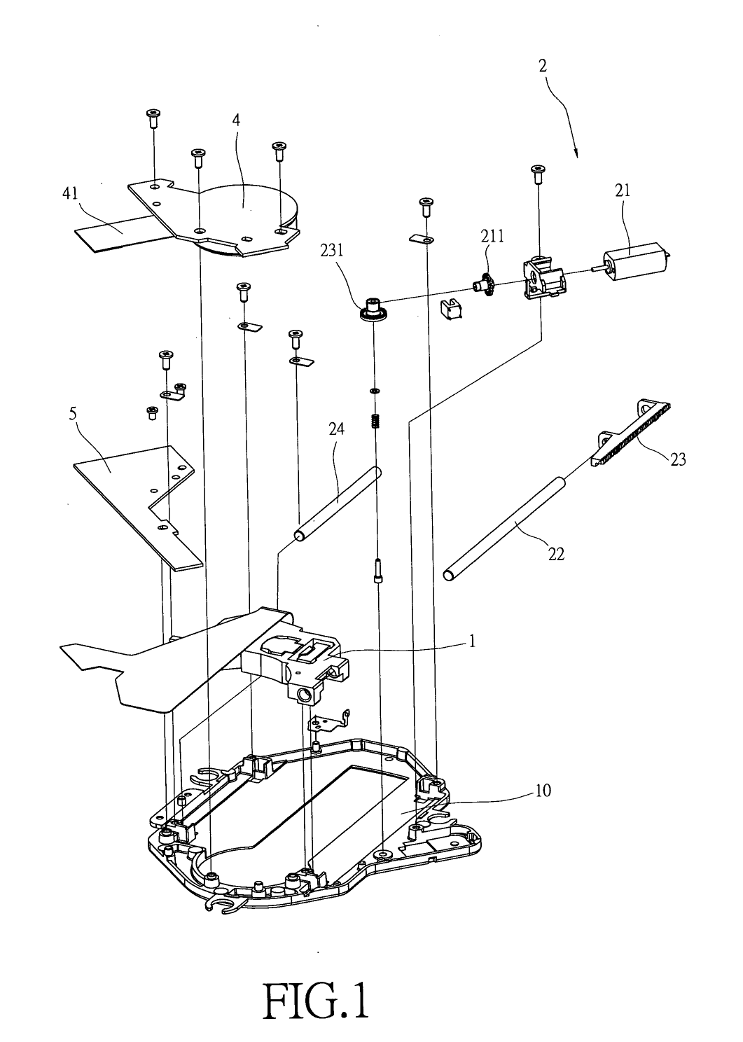

Referring to FIG. 1, a movement is shown mounted in a casing 10, comprising a read head 1, a moving mechanism 2 a driving motor 3, a ferrite substrate 4, and at least one control circuit 5.

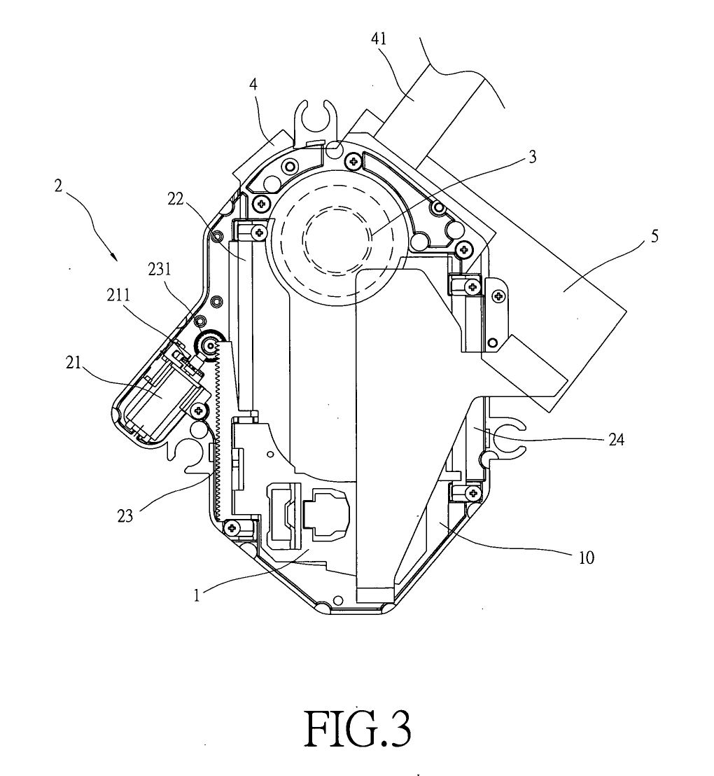

Referring to FIG. 3 and FIG. 1 again, the read head 1 is driven to move in the casing 10 by the moving mechanism 2 to access data from the disk (not shown).

Referring FIGS. 1 and 3 again, the moving mechanism 2 comprises a driving source 21, a first gear 211 pivotally coupled to the front side of the driving source 21, a first rail 22, a second rail 24, a rack 23 axially mounted on the first rail 22 and linked to one side of the read head 1, which has the other side coupled to the second rail 24, a second gear 231 meshed between the rack 23 and the first gear 211. Preferably, the driving source 21 is a motor drive.

The driving motor 3 is mounted on the ferrite substrate 4, which is fixedly fastened to the casing 10 at one side. A signal transmission bus line 41 is connected between the ferrite substrate 4 and the driving motor 3 for signal transmission.

The control circuit 5 is installed in the casing 10 at one side. Because the ferrite substrate 4 and the control circuit 5 are independent members and separately prepared, the size ferrite substrate 4 can be minimized to reduce the cost and to facilitate precise installation. Further, the control circuit 5 can selectively be installed in the casing 10, or another location in the disk player. According to the present invention, the control circuit 5 is made in the form of a printed circuit board.

As indicated above, the invention has the control PC board and the ferrite substrate separately designed so that the installation procedure can be simplified, the product size can be minimized, and the manufacturing cost can be greatly reduced.

A prototype of movement for disk player has been constructed with the features of FIGS. 1˜3. The movement for disk player functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

1. A movement for disk player comprising:
a disk read head;
a read head moving mechanism;
a disk driving motor;
a ferrite substrate for disk driving motor; and
at least one driving motor control circuit, disposed outside said ferrite substrate.

2. The movement for disk player as claimed in claim 1, wherein said moving mechanism comprising a driving source, a first gear coupled to said driving source, a first rail and a second rail, a rack mounted on said first rail, and a second gear meshed between said first gear and said rack.

3. The movement for disk player as claimed in claim 1, further comprising a signal bus line connected between said ferrite substrate and said disk driving motor.

4. The movement for disk player as claimed in claim 2, wherein said driving source of said moving mechanism is a motor.

5. The movement for disk player as claimed in claim 1, wherein said control circuit is made in a form of a printed circuit board.
